(19) United States
(12) Patent Application Publication
(10) Pub. No.: US 2025/0277362 A1
(43) Pub. Date: Sep. 4, 2025

(54) PHASE CHANGE MATERIAL (PCM) INSULATED PANELS WITH PCM AND METHODS OF MANUFACTURING THE PCM INSULATED PANELS

(71) Applicant: NUCOR INSULATED PANEL GROUP, LLC, Wilmington, DE (US)

(72) Inventors: Brittany Crawford, Lewisville, TX (US); Brandon Cook, Crossroads, TX (US); Jennifer Franz, Frisco, TX (US)

(73) Assignee: NUCOR INSULATED PANEL GROUP, LLC, Wilmington, DE (US)

(21) Appl. No.: 19/061,223

(22) Filed: Feb. 24, 2025

Related U.S. Application Data
(60) Provisional application No. 63/560,396, filed on Mar. 1, 2024.

(51) Int. Cl. E04B 1/80; B29D 7/01; B29K 75/00; B29K 105/04; B32B 5/18; B32B 27/40; F16L 59/02

(52) U.S. Cl. CPC E04B 1/80; B29D 7/01; B32B 5/18; B32B 27/40; F16L 59/028; B29K 2075/00; B29K 2105/04; B32B 2266/0278; B32B 2305/022; B32B 2307/304; B32B 2307/3065

(57) ABSTRACT

Insulated panels that incorporate phase-change material (PCM) into the insulation material. The PCM is a solid-to-solid phase change material that is microencapsulated into the insulation. Moreover, the PCM may be tuned for particular applications (e.g., types of buildings, locations of the buildings in a region, climate, or the like). As such, the PCM insulated panel having the PCM insulation material may utilize target phase-change temperatures based on the building application. The unexpanded PCM insulation material may be formed and utilized such that traditional insulated panel equipment may be utilized to form an insulated panel with PCM material located in the insulation material. As such, the present disclosure allows for design, manufacture, and installation of improved PCM insulated panel systems that provide improved thermal protections for building applications.

### CROSS REFERENCE AND PRIORITY CLAIM UNDER 35 U.S.C. § 119

This application claims priority to U.S. Provisional Application No. 63/560,396 entitled “Phase Change Material (PCM) Insulated Panels with PCM and Method of Manufacturing the PCM Insulated Panels” filed on Mar. 1, 2024, both of which are assigned to the assignee hereof and the entirety of which is incorporated by reference herein.

### FIELD

This application relates generally to the field of insulated panels for buildings, and more particularly, to phase change insulated panels and the manufacturing and installation of the phase change insulated panels.

### BACKGROUND

Current building envelope methodology provides insulation for thermal protection regardless of the application. Present systems use the same insulated panels to provide thermal protection regardless of the use of the building and/or the location of the building. There is a need for providing improved thermal protection to building applications.

### BRIEF SUMMARY

Embodiments of the present disclosure relate to improved insulated panels that incorporate phase-change material (PCM) into the insulation material. The PCM is a solid-to-solid phase change material that is microencapsulated into the insulation. Moreover, the PCM may be tuned for particular applications (e.g., types of buildings, locations of the buildings in a region, or the like). As such, the PCM insulated panel having the PCM insulation material may utilize target phase-change temperatures based on the building application. The unexpanded PCM insulation material may be formed and utilized such that traditional insulated panel equipment may be utilized to form an insulated panel with PCM material located in the insulation material.

The present disclosure allows for the design, manufacture, and installation of improved PCM insulated panel systems that provided improved thermal protection for building applications. That is, when the PCM insulated panel has a phase-change temperature that is below the ambient temperature (e.g., outside temperature), the PCM insulated panel will absorb thermal energy from the ambient environment and store the thermal energy for future release. As such, the costs to cool the building may be reduced because not as much heat is being transferred to the building. Alternatively, when the PCM insulated panel has a phase-change temperature that is above the ambient temperature, the PCM insulated panel will release thermal energy to the ambient environment. As such, the costs to heat a building may be reduced because not as much heat is being transferred away from the building.

One embodiment of the present disclosure is a phase-change insulated panel comprising a first substrate, a second substrate, an insulation material located between the first substrate and the second substrate. The insulation material comprises a phase change material (PCM) microencapsulated within the insulation material. The PCM is a solid-to-solid PCM.

In further accord with embodiments, the insulation material is formed from an unexpanded insulation material comprising a polyol, an isocyanate, and the PCM. The unexpanded insulation material is deposited between the first substrate and the second substrate in a liquid form or a foam form and allowed to expand into the insulation material.

In other embodiments, the unexpanded insulation material further comprises a catalyst, a fire retardant, a surfactant, processing additives, and water.

In yet other embodiments, the insulation material is a polyurethane foam with the microencapsulated PCM.

In still other embodiments, the insulation material is a polyisocyanurate foam with the microencapsulated PCM.

In other embodiments, the insulation material is applied as liquid PCM material with the microencapsulated PCM within the liquid PCM and allowed to harden into the insulation material.

In further accord with embodiments, a phase change of the PCM within the insulation material occurs at a temperature range from 64.4 to 80.6 degrees F.

In other embodiments, a phase change of the PCM within the insulation material occurs at a temperature range from 33.8 to 46.4 degrees F.

In still other embodiments, a phase change of the PCM within the insulation material occurs at a temperature range from −11.2 to 6.8 degrees F.

In yet other embodiments, a phase change of the PCM within the insulation material occurs at a temperature range from −49 to −29.2 degrees F.

Another embodiment of the present disclosure is method of forming a phase-change insulated panel. The phase-change insulated panel comprises a first substrate, a second substrate, and an insulation material between the first substrate and the second substrate. The insulation material comprises a phase change material (PCM) microencapsulated within the insulation material. The PCM is a solid-to-solid PCM. The method comprises dispensing an unexpanded insulation material onto at least a first substrate through an applicator in a liquid form or a foam form. The method further comprises allowing the unexpanded insulation material to expand into the insulation material between the first substrate and a second substrate.

In further accord with embodiments the applicator comprises one or more stationary nozzles.

In other embodiments, the method further comprises applying the second substrate to the insulation material, and laminating the first substrate, the insulation material, and the second substrate together as the unexpanded insulation material is expanding into the insulation material.

In yet other embodiments, the applicator comprises one or more moveable nozzles.

In still other embodiments, the method further comprises inserting the applicator into a first mold between the first substrate and the second substrate. Moreover, the dispensing occurs as the applicator is withdrawn from the mold.

In other embodiments, the unexpanded insulation material comprises a polyol, an isocyanate, and the PCM.

In further accord with embodiments, the unexpanded insulation material further comprises a catalyst, a fire retardant, a surfactant, processing additives, and water.

In other embodiments, the insulation material is a polyurethane foam with the microencapsulated PCM or a polyisocyanurate foam with the microencapsulated PCM.

In yet other embodiments, a phase change of the PCM within the insulation material occurs at a temperature range from 64.4 to 80.6 degrees F. or at a temperature range from 33.8 to 46.4 degrees F.

In still other embodiments, a phase change of the PCM within the insulation material occurs at a temperature range from −11.2 to 6.8 degrees F. or at a temperature range from −49 to −29.2 degrees F.

To the accomplishment of the foregoing and the related ends, the one or more embodiments of the invention comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF DRAWINGS

The accompanying drawings illustrate some of the embodiments of the invention and are not necessarily drawn to scale, wherein:

FIG. 1 illustrates a perspective view of a barrier system having a plurality of barrier panels installed on support members, in accordance with embodiments of the present disclosure;

FIG. 2A illustrates a front perspective view of a heavy gauge barrier panel being installed on an I-beam support member, in accordance with embodiments of the present disclosure;

FIG. 2B illustrates a rear perspective view of the heavy gauge barrier panel of FIG. 2A that also utilizes a rear connection, in accordance with embodiments of the present disclosure;

FIG. 3A illustrates a front perspective view of a light gauge barrier panel being installed on an z-shaped support member, in accordance with embodiments of the present disclosure;

FIG. 3B illustrates a rear perspective view of the light gauge barrier panel of FIG. 3A that also utilizes a rear connection, such as a rivets, in accordance with embodiments of the present disclosure;

FIG. 4A illustrates an end view of a phase-change material (PCM) insulated panel, in accordance with embodiments of the present disclosure;

FIG. 4B illustrates a cross-sectional view of a first PCM insulated panel being assembled with a second PCM insulated panel along the edges, in accordance with embodiments of the present disclosure;

FIG. 4C illustrates a cross-sectional view of first and second PCM insulated panels assembled along the edges, in accordance with embodiments of the present disclosure;

FIG. 5A illustrates a perspective and enlarged view of a flat phase-change insulated panel, in accordance with embodiments of the present disclosure;

FIG. 5B illustrates a perspective and enlarged view of a striated phase-change insulated panel, in accordance with embodiments of the present disclosure;

FIG. 5C illustrates a perspective and enlarged view of a corrugated phase-change insulated panel, in accordance with embodiments of the present disclosure;

FIG. 6 illustrates a schematic of an unexpanded insulation material having the PCM micro-encapsulated within the unexpanded insulation material, in accordance with embodiments of the present disclosure;

FIG. 7A illustrates a schematic diagram of a continuous panel manufacturing line with a laminator, in accordance with embodiments of the present disclosure;

FIG. 7B illustrates a perspective view of a portion of a continuous panel manufacturing line, in accordance with embodiments of the present disclosure;

FIG. 7C illustrates a perspective view of a portion of a continuous panel manufacturing line, in accordance with embodiments of the present disclosure;

FIG. 8A illustrates a perspective view of a static applicator dispensing a liquid insulation material, in accordance with embodiments of the present disclosure;

FIG. 8B illustrates a perspective view of the insulation applicator dispensing a foam insulation material, in accordance with embodiments of the present disclosure;

FIG. 8C illustrates the insulation material expanding in the liner entry before the laminator, in accordance with embodiments of the present disclosure;

FIG. 8D illustrates a perspective side view of the laminator, in accordance with embodiments of the present disclosure;

FIG. 8E illustrates a perspective end view of the laminator, in accordance with embodiments of the present disclosure;

FIG. 9A illustrates a perspective view of a discontinuous panel manufacturing line with static molds, in accordance with embodiments of the present disclosure;

FIG. 9B illustrates a perspective view of a discontinuous panel manufacturing line with a dynamic applicator and static molds, in accordance with embodiments of the present disclosure;

FIG. 10 illustrates sample regions in the United States for insulation panel applications, in accordance with embodiments of the present disclosure; and

FIG. 11 illustrates a process for manufacturing PCM insulated panels and the operation of the installed PCM insulated panels, in accordance with embodiments of the present disclosure.

### DETAILED DESCRIPTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

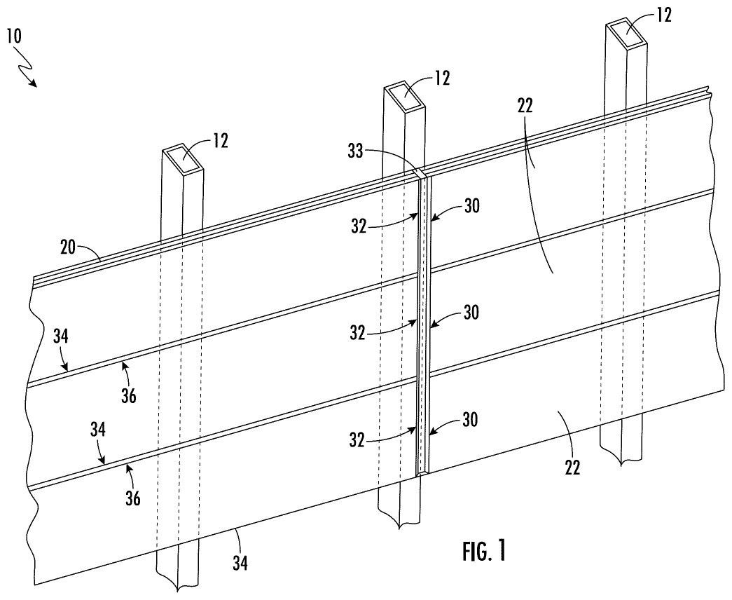

FIG. 1 illustrates a portion of building envelope system 10, in accordance with the teachings of the present invention. The building envelope system 10 includes support members 12 (e.g., vertical support members, such as studs, I-beams, z-channels, or the like made of any material), which are structurally connected to other building support members (e.g., floors, girders, joists, or the like) directly or indirectly. A barrier panel system having barrier panels may be attached to the support members 12 to provide one or more benefits, such as air, water, vapor, and/or thermal protection. In some embodiments of the present invention, the barrier system is an insulated panel system that uses insulated panels to provide thermal protection. In particular embodiments of the present disclosure, the insulated panel system is a PCM insulated panel system 20 that utilizes a plurality of phase-change (PCM) insulated panels 22, as will be described in further detail herein. In some embodiments, an exterior system (not illustrated) may be attached to the outer surface of the barrier system via an exterior panel connector. It should be understood that the PMC insulated panels 22 may be generally used on the walls of a structure, but they may also be used as roof panels (e.g., attached to structural members, such as joists, purlins, or the like), or otherwise anywhere on the structure. Furthermore, in some embodiments, in addition to providing insulation to the structure the PMC insulated panels 22 may also act as structural members that provide diaphragm shear strength to the structure (e.g., when connected to other structural members).

As illustrated in FIGS. 1 through 5C, the insulated panels, and in particular the PCM insulated panels 22, may have substrates (otherwise described as faces, skins, or the like), such as a first substrate 24 (e.g., first face, first skin, or the like) and a second substrate 26 (e.g., second face, second skin, or the like). It should be understood that the first substrate 24 may be the exterior face and the second substrate 26 may be interior face; however, the second substrate 26 may be the exterior face and the first substrate 24 may be the interior face. The first substrate 24 and/or the second substrate 26 are typically made from steel, such as G90 galvanized steel, for structural strength purposes and to resist corrosion. However, other metallic materials, other materials, and/or combinations of materials, such as aluminum, composites, and other similar materials, are also contemplated for the substrates 24, 26. Moreover, the PCM insulated panels 22 may have ends, such as a first end 30 (e.g., left end, proximal end, or the like) and a second end 32 (e.g., right end, distal end, or the like), and edges, such as a first edge 34 (e.g., a lower edge, proximal edge, or the like) and a second edge 36 (e.g., upper edge, distal edge, or the like). As illustrated in FIG. 1, multiple PCM insulated panels 22 may be installed (e.g., such as adjacent the floor, base, or the like) of a building onto one or more support members 12 to form a PCM insulated panel system 20. The PCM insulated panel 22 may extend over two or more support members 12. As illustrated in FIG. 1, a first end 30 of a first panel 22 may butt up to a second end 32 of a second panel 22 (e.g., horizontally end to end). As illustrated in FIG. 1, the ends 30, 32 of adjacent panels 22 may butt up to each other at the locations of a support member 12. However, it should be understood that the ends 30, 32 of adjacent panels 22 may butt up to each other at locations between support members 12. While the ends 30, 32 of the panels 22 are illustrated as butting up to each other, in some embodiments, the ends 30, 32 of the panels 22 may at least partially overlap. Moreover, in some embodiments end connectors (e.g., fasteners, clips, or the like) may be used to operatively coupled the ends 30, 32 of adjacent panels together. Alternatively, or additionally, a seal 33 (e.g., gasket seal, adhesive, caulk, tape, or the like) may be located between a portion of adjacent panels 22, such as the ends 30, 32 of the panels 22 as illustrated in FIG. 1.

As further illustrated in FIGS. 1 through 5C, multiple panels 20 may be assembled on top of each other using the edges 34, 36 of the panels 20. For example, as illustrated in FIG. 1, a first edge 34 of one panel 22 may be operatively coupled to a second edge 36 of an adjacent panel 22 (e.g., vertically edge to edge). As illustrated in FIGS. 1 through 5C, the edges 34, 36 of the panels 22 may have one or more projections 40 that form one or more cavities 42 on one or both edges 34, 36 of the panels 22. The one or more projections 40 and one or more cavities 42 are used to interlock a first edge 34 of a first panel 22 with a second edge 36 of an adjacent second panel 22. The interlocking of the edges 34, 36 creates and/or improves the restriction of (e.g., reduces or eliminates) the passage of air, water, vapors, heat, or the like between the edges 34, 36 of the adjacent panels 22.

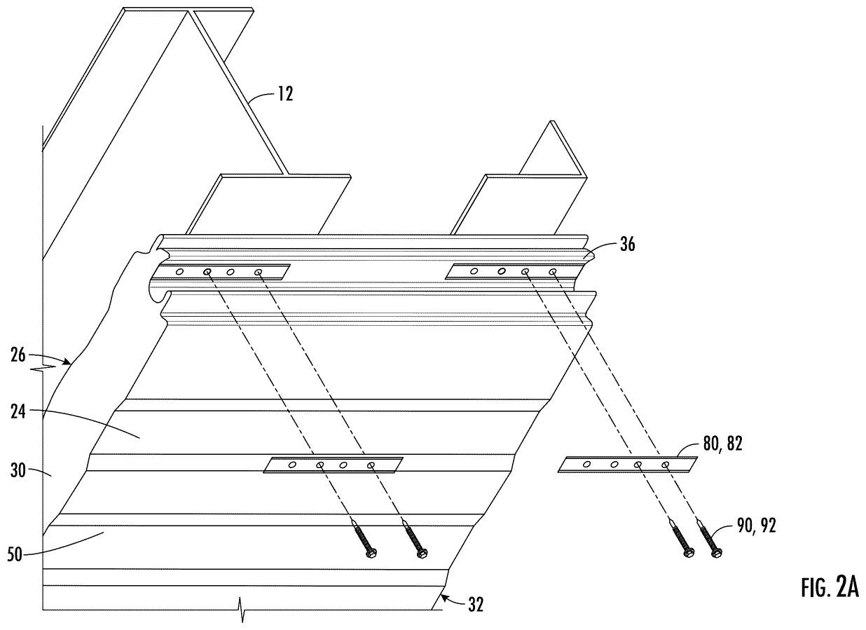

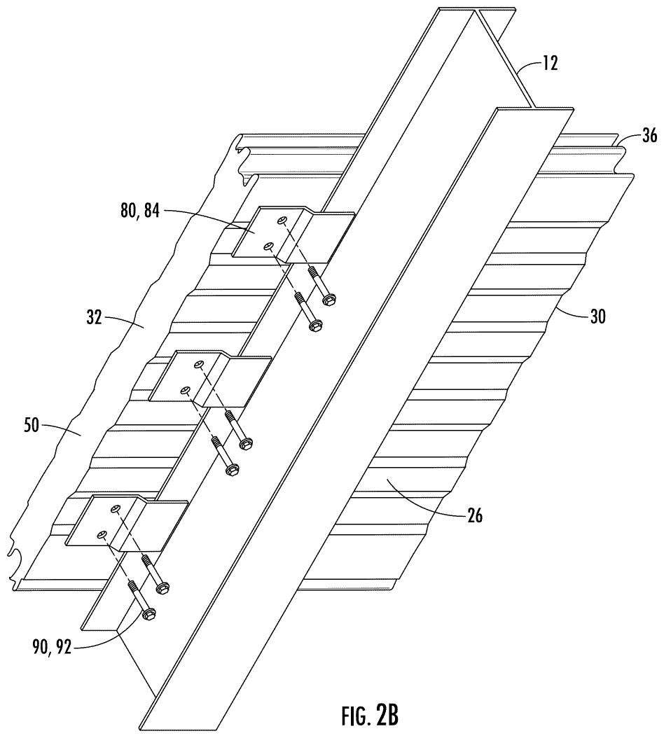

The panels 22 may be operatively coupled to the support members 12 in various ways dependent on the type of panel, weight of the panel, edges 34, 36, ends 30, 32, or the like of the panels 22. For example, referring to FIGS. 2A and 2B, the PCM insulated panel 22 may be a heavy gauge panel (e.g., 20, 22, 24, or the like gauge) that is operatively coupled to a support member 12 that is an I-beam or an H-beam. As illustrated in FIGS. 2A and 2B, the PCM insulated panel 22 may be attached through the use of retainer members 80 (e.g., rectangular, square, oval, uniform, non-uniform, z-shaped, s-shaped, c-shaped, L-shaped, or the like members) that may have one or more apertures therein, and/or connectors 90 (e.g., fasteners, such as rivets, screws, bolts, nuts, or the like, clamps, clips, or the like connectors). For example, the edge retainer members 82 may be located within a channel on an edges 34, 36 of the panels 20 and operatively coupled to the support member 12 using the fasteners 92, such as rivets. For example, in some embodiments the edge retainer members 82 may be used to operatively couple the second edge 36 of the panel to the support member 12 using the fasteners 92. Additionally, face retainer members 84 may be used to operatively couple the support member 12 to second face 26 of the panel 22, as illustrated in FIG. 2B.

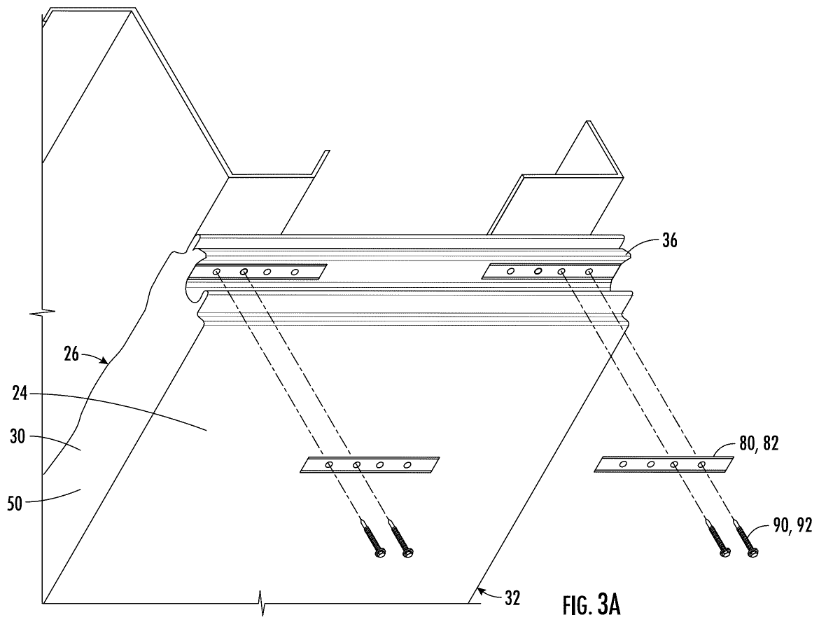

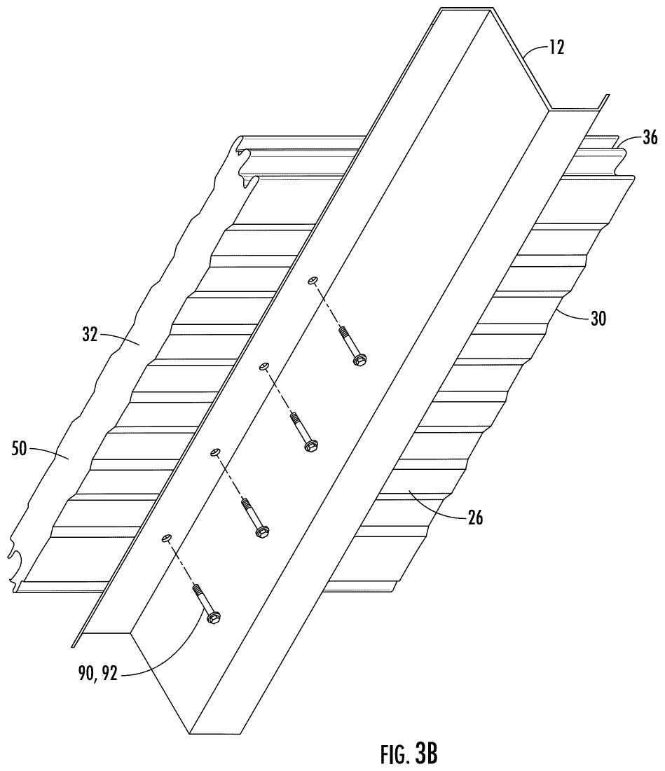

In other examples, referring to FIGS. 3A and 3B, the PCM insulated panel 22 may be a light gauge panel (e.g., 24, 26, 28, or the like gauge) that is operatively coupled a support member 12 that is a z-shaped wall support. As illustrated in FIGS. 3A and 3B, like the insulated panels 22 illustrated in FIGS. 2A and 2B, the insulated panels 22 may be attached through the use of retainer members 80 (e.g., rectangular, square, oval, uniform, non-uniform, z-shaped, s-shaped, c-shaped, L-shaped, or the like members) that may have one or more apertures therein, and/or connectors 90 (e.g., fasteners 92, such as rivets, screws, bolts, nuts, or the like, clamps, clips, or the like connectors). The retainer members 80 may be located within a channel on an edges 34, 36 of the panels 20 and operatively coupled to the support member 12 using the fasteners 92. For example, edge retainer members 82 may be located within a channel on an edges 34, 36 of the panels 20 and operatively coupled to the support member 12 using the fasteners 92. However, unlike the connection in FIGS. 2A and 2B, the face retainer members 84 may not be necessary, and instead the connectors 90, such as the fasteners 92, may be used to operatively couple the support member 12 directly to the second face 26 of the panel 22, as illustrated in FIG. 3B.

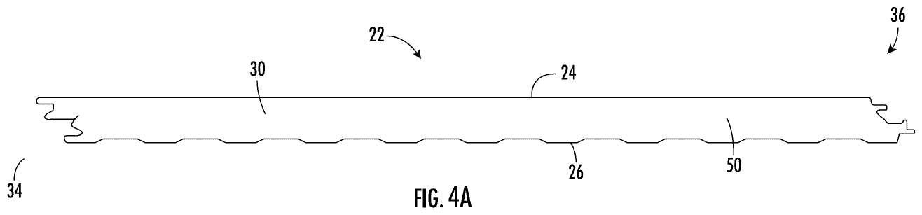

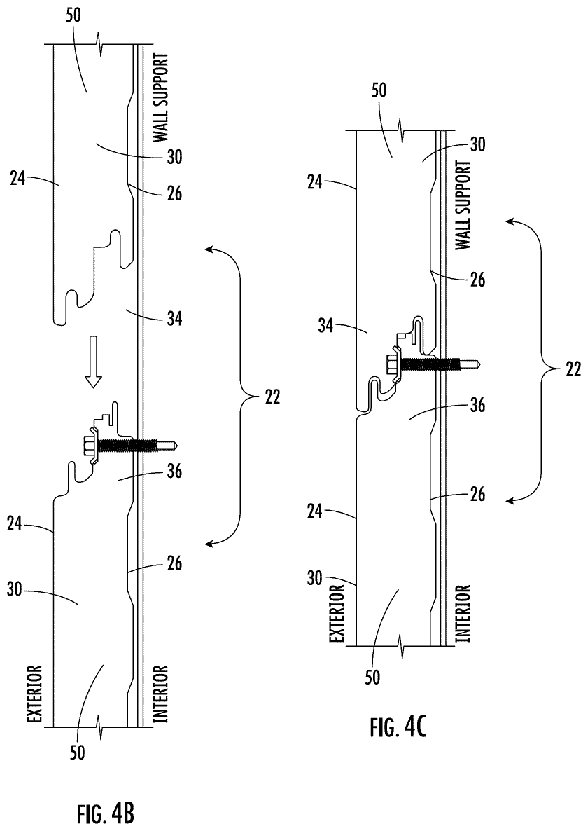

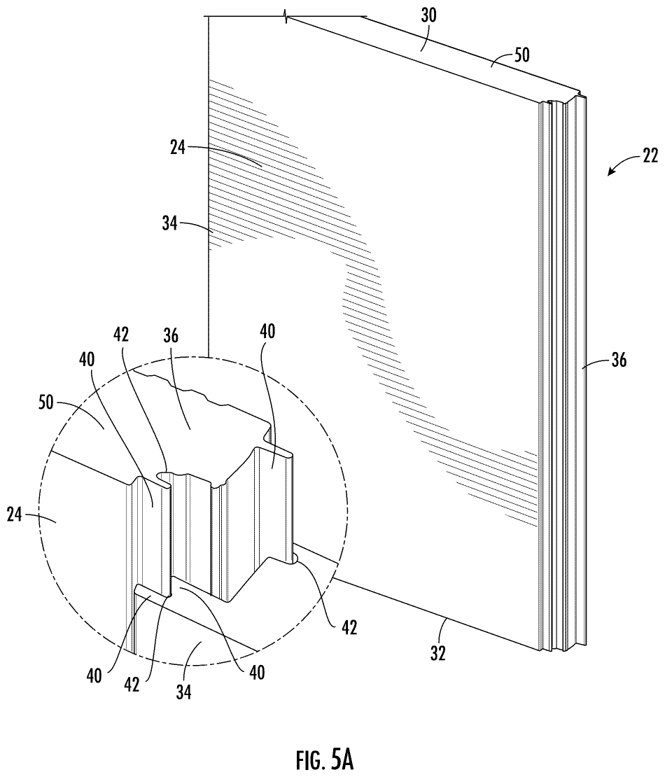

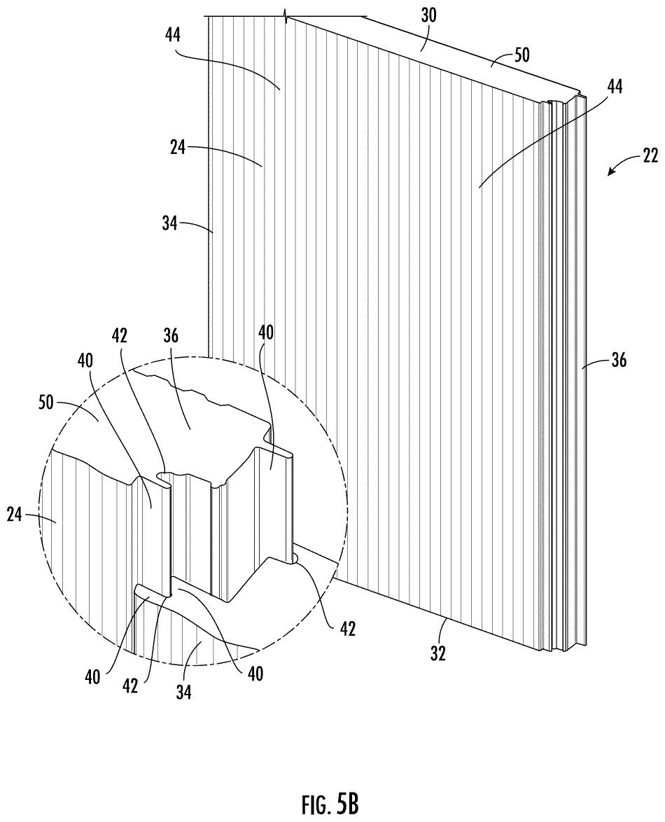

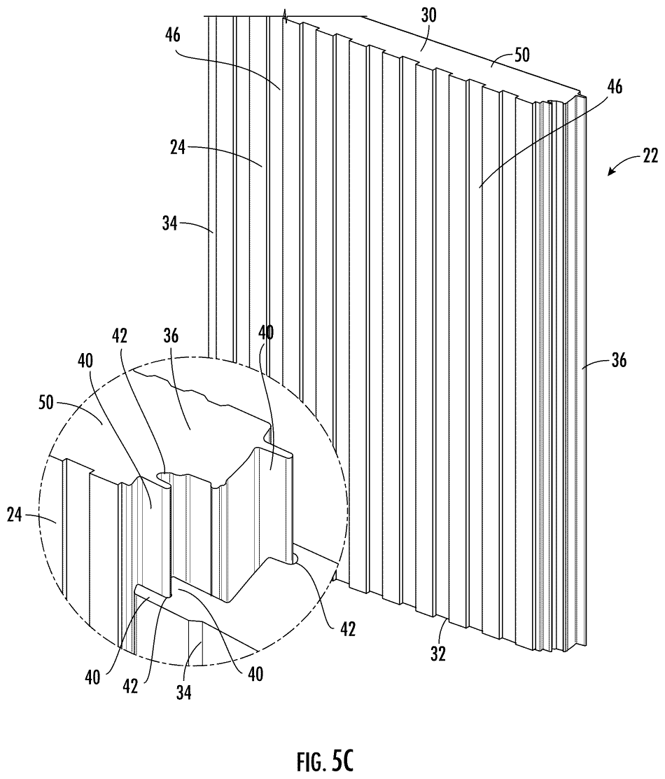

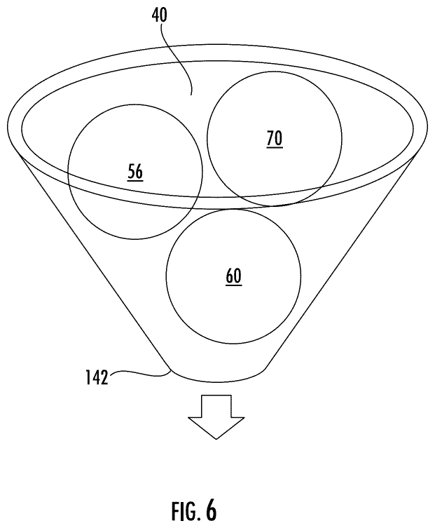

FIGS. 4A through 5C illustrate that the plurality of projections 40 and cavities 42 formed from the projections 40 on the first edge 34 of a first panel 22 and a second edge of an adjacent second panel 22 may be used to connect adjacent panels 22. FIG. 5A illustrates one type of panel 22 that may have a first substrate 24 that is flat. Alternatively, FIG. 5B illustrates another type of panel 22 that includes striations 44 in the first substrate 24 (e.g., 1/64, 1/32, 1/16, or the like inches deep, or range between, overlap, or fall outside of these values). FIG. 5C illustrates another type of panel 22 that includes corrugations 46 in the first substrate 24 (e.g., 1/16, ⅛, ¼, or the like inches deep, or range between, overlap, or fall outside of these values). It should be further understood that regardless of whether or not the panels have striations 44 and/or corrugations 46, the panels 22 may be embossed or non-embossed. Furthermore, while the panels 22 are illustrated as being flat, having striations 44, and/or corrugations 46 on the first substrate 24 it should be understood that the second substrate 26 may or may not have these features. Furthermore, it should be understood that the substrates may have different surface shapes (e.g., circle, half-circles, triangles, rectangles, squares, any polygon, uniform, non-uniform, or the like shape), patterns, and/or sizes.

It should be understood that while particular panels 22 are illustrated herein, it should be understood that any type of panel having any type of shape and/or configuration may be used as the phase-change material (PCM) insulated panel 22 described herein. The PCM insulated panels 22 may include an insulation material 50 (otherwise described as a foam core, or the like) filling the interior space of the PCM insulated panel 22 and adhesively connecting the facing substrates 24, 26 to provide a PCM insulated panel 22. In particular embodiments as illustrated in FIG. 6, the insulation material 50 comprises a polyol 56 (i.e., polyfunctional alcohols), an isocyanate (e.g., methylene diphenyl diisocyanate, or the like), and a phase change material (PCM) 60. The polyol 56 and the isocyanate react and form a polyurethane or a polyisocyanurate insulation material 50. The insulation material 50 may further comprise a catalyst(s), a fire retardant(s), surfactant(s), processing additive(s), blowing agent(s), and/or water. The catalysts are used to control the rate of reaction for the manufacturing process by affecting the flow of unexpanded insulation material, the skin formation, and the demolding time. The fire retardants are used to reduce the burn rate and smoke generated by the insulation material 50 during a fire. The surfactants are used to lower the surface tension and promote uniform cell size. The blowing agents, such as pentanes, are used to allow expansion of the insulation material (e.g., 10, 20, 30, 40, 50, or the like times the original unexpanded volume). The water may be used as secondary blowing agent.

The PCM 60 in particular embodiments is a solid-to-solid phase change material. The solid-to-solid PCM 60 may absorb and release heat by reversible phase transitions between a first solid phase (e.g., crystalline or semi-crystalline phase) to another second solid phase (e.g., amorphous, semi-crystalline, or crystalline). The PCM 60 is a substance capable of storing and releasing energy at phase transition temperature to provide useful energy for cooling or heating. The transition temperature of the phase change may occur within the range of −4 deg F. (−20 deg C.) and 212 deg F. (100 deg C.), inclusive. The PCM 60 remains in solid phase at the transition temperature, maintaining the structural integrity of the PCM insulated panel 22. The specific PCM 60 used for specific applications will be described in further detail herein. The solid-to-solid PCMs avoid the leakage problems with solid-to-liquid PCM because the solid-to-solid PCMs do not require the structural encapsulation that the solid-to-liquid PCMs require to prevent leakage of the PCM when the PCM is in the liquid phase. Moreover, solid-to solid PCMs experience less phase-segregation and smaller volume changes since any soft sections (as will be described in further detail below) are immobilized, which aids in preventing degradation of the PCM during thermal cycling. As such, the durability of the solid-to-solid PCM is improved. Furthermore, solid-to-solid PCM allow for a wide range of enthalpy, transition temperature, and thermal conductivity values.

The four main types of solid-to-solid PCMs 60 are organic, polymetric, organo metallic, and/or inorganic solid-to-solid PCMs, and may be achieved in two main approaches. The first being, arrangement of small molecule changes from one crystalline phase to another (e.g., plastic crystal PCMs). Within this approach polyalcohol organic compounds may change from a layered or chainlike tetrahedral arrangement (e.g., at lower temperatures) to a cubic crystalline arrangement (e.g., disordered arrangement at higher temperatures). At extremely high temperatures the solid PCM will eventually transform into a liquid. The temperature at which the phase-change occurs may be changed by mixing different types of poly-alcohols. In another example of this approach, the PCM 60 may be an inorganic solid-to-solid PCM that absorbs and releases energy through magnetically induced, crystalline, or order-disorder transformations. For example, Fe—Co binary system may be formed.

In the second approach, crystallizable moieties are incorporated through chemical binding into another structure that restricts the flow of the moieties when they are in the liquid phase. For example, with respect to solid-to-solid polymetric PCMs, the phase-change component is incorporated structurally into the macromolecular backbone through sidechain grafting, block-polymerization, hyper-branching, or crosslinking copolymerization with non-crystallizable motifs. In this way, the PCMs include soft segments bonded to hard segments. When the soft segments reach their melting point, the PCM absorbs heat while undergoing the phase transformation. However, since the soft segments are bonded to hard segments the movement of the soft segments are restricted, such that PCM remains solid. The temperature at which the phase-change occurs may be changed by adjusting the chain length of the soft segments or the rigidity of the harder backbone segments. In other embodiments of this approach, perovskites, inorganic crystalline sheets are attached to crystallizable soft segments that are attached through non-covalent bonds. In this way, when the soft segments of the bonded segments melt the movement of the soft segments are restricted such that the overall system remains solid.

It should be understood that while the types solid-to-solid PCMs 60 and the approaches for creating the solid-to-solid phase change are described herein, it should be understood that any type of solid-to-solid PCMs may be used and/or created through any approach. It should be understood that the present disclosure includes the use of the solid-to-solid PCMs in an unexpanded insulation material that may be used within insulated panel manufacturing equipment, and the use of the PCM insulated panels in different applications based on the phase-change temperature of the PCM insulated panels for the particular application. As such, it should be understood that the ultimate storage capacity of the PCM 60 may be based on the packing density of the molecules within the crystalline system, while the phase-change temperature may be set by the strength of the non-covalent bonding between the molecules.

In alternate embodiments, instead of a solid-to-solid PCM, a solid-to-gel PCM may be used, which may be structured similarly as the solid-to-solid PCMs. In other embodiments solid-to-liquid PCMs may be used. However, with respect to the solid-to-liquid and/or the solid-to-gel PCMs, these materials may be required to be encapsulated within a panel 22 directly or through the use of a sealed container (e.g., solid, flexible, or the like) within the panel 22, in order to restrict leakage of the material when it is in the gel and/or liquid phases.

As will be described in further detail herein, the insulation material 50 is applied as an unexpanded material 52 (e.g., a liquid material, a foamed material 54, depending on the equipment being used) and expands and hardens into the insulation material 50 of the PCM insulated panel 22. Regardless of how the insulation material 54 is applied, the PCM 60 is micro-encapsulated within the unexpanded material 52 before it is applied and allowed to harden into the insulation material 50. By micro-encapsulating the PCM 60, the insulated material 50 saves energy by absorbing and storing thermal energy during high thermal load (high temperature) periods, and thus reducing the cooling requirements for facilities, and provides energy by releasing energy during low thermal load (low temperatures) periods, and thus reducing the heating requirements for facilities in which the PCM panel system 20 is utilized.

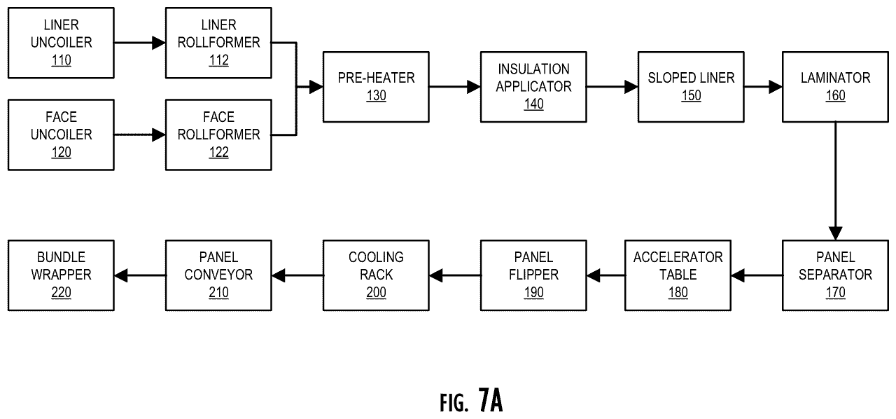

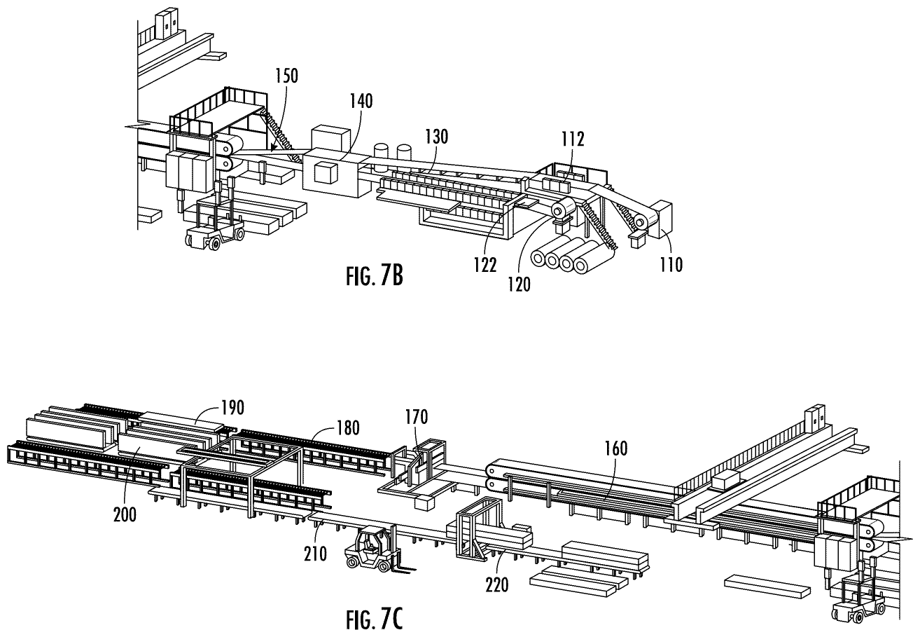

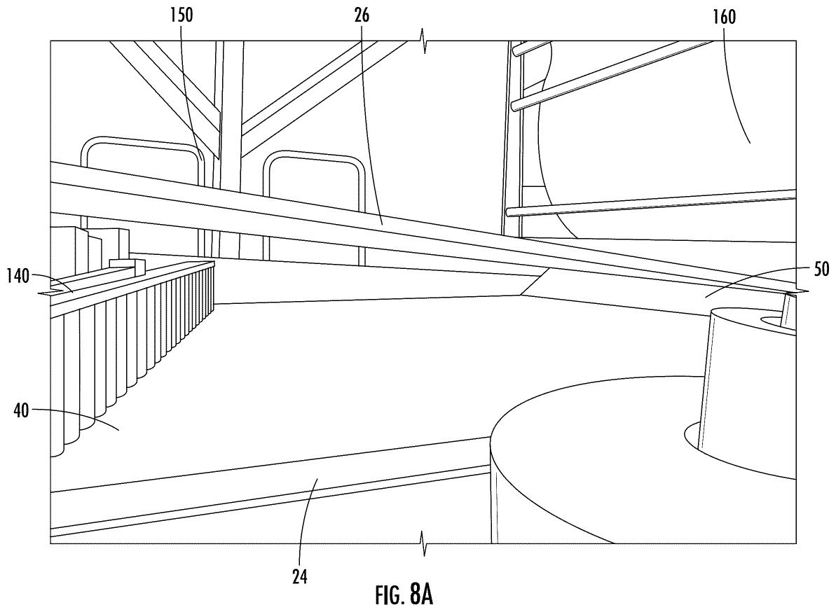

It should be understood that the unexpanded material 52 may be utilized in different types of panel forming equipment and/or process. However, in particular embodiments the processing equipment may be continuous processing equipment or foamed in place equipment. FIGS. 7A through 7C illustrates one type of insulated panel processing equipment 100 and process of manufacturing the PCM insulated panels 22 using continuous panel manufacturing equipment. As illustrated, the PCM insulated panel 22 may be formed through the use of an upper uncoiler 210 (e.g., liner uncoiler, or the like), which may uncoil a steel roll and an upper rollformer 212 (e.g., a liner rollformer, or the like) may roll the steel sheet into the desired shape for an upper substrate. Moreover, a lower uncoiler 20 (e.g., face uncoiler, or the like) may uncoil a steel roll and a lower rollformer 222 (e.g., a face rollformer, or the like) may roll the steel sheet into the desired shape for the lower substrate. It should be understood that the upper equipment and the lower equipment may form either of the first substrate 24 or the second substrate 26 depending on the equipment and process being used.

As further illustrated in FIGS. 7A through 7C, a pre-heater 230 may be utilized in order to heat one or more of the substrates 24, 26 for depositing of the unexpanded insulation 52 (e.g., the liquid insulation 54 or the foam insulation 54) onto one of the substrates 24, 26.

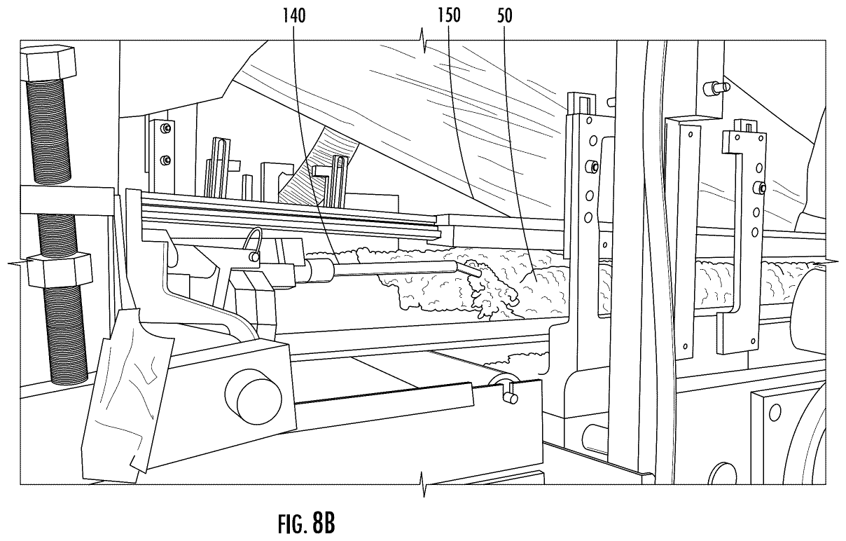

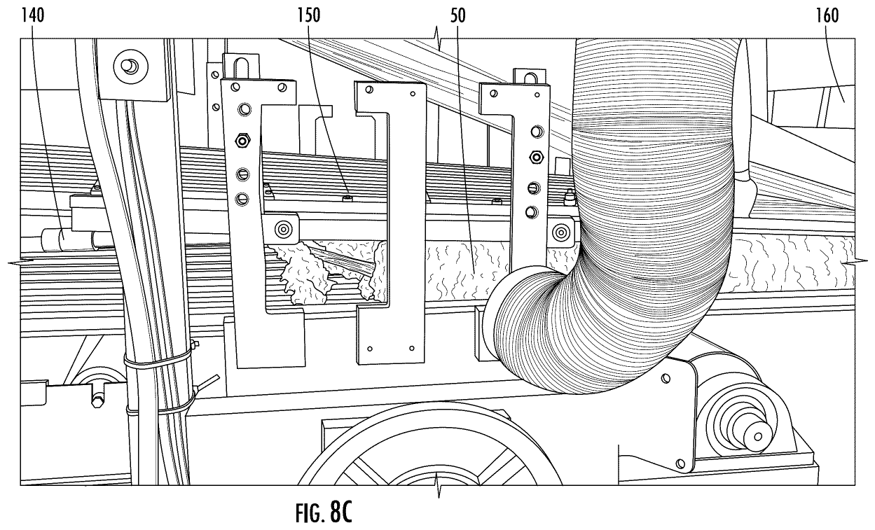

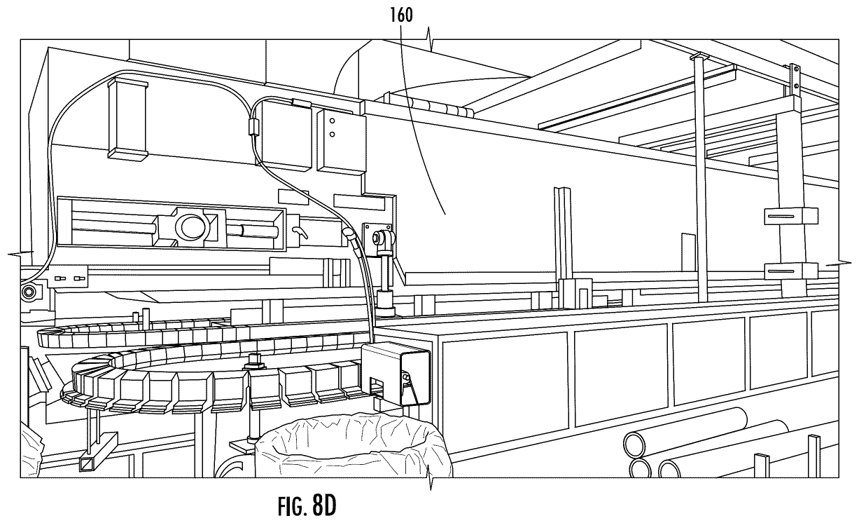

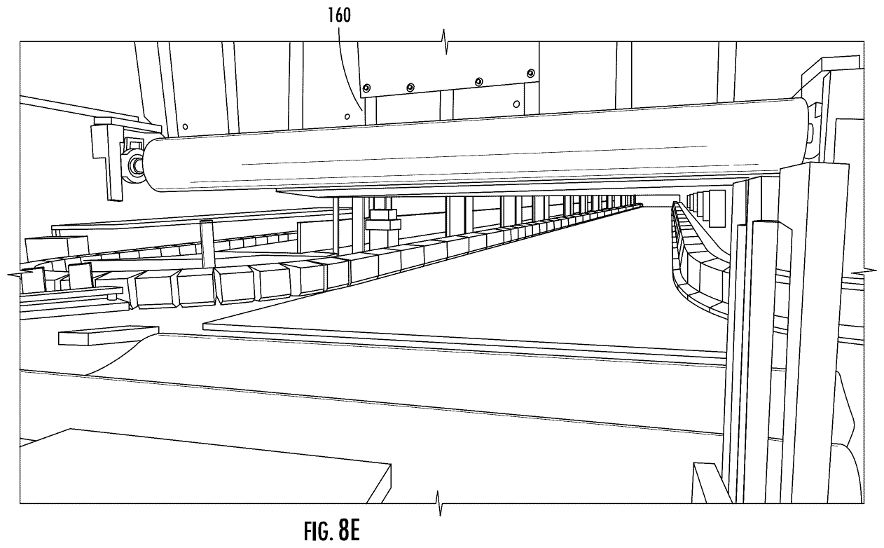

As further illustrated in FIGS. 7A through 7C, the insulation applicator 140 applies the unexpanded insulation material 52 in a liquid form, as illustrated in FIG. 8A, or in a foam form, as illustrated in FIG. 8B. In the illustrated embodiment in FIG. 8A, the insulation applicator 140 comprises of a plurality of liquid dispensing nozzles that are stationary and that deposit the liquid insulation material 52 over at least a portion of one of the substrates, such as the first substrate 24. As the first substrate 24 and the second substrate 26 move down the line toward the laminator 160, which will be described in further detail herein, the insulation material begins to expand between the first substrate 24 and the second substrate 26. In alternate embodiments, as illustrated in FIG. 8B, the insulation applicator 140 may apply the unexpanded insulation material 52 as expanding foam insulation 54. In this embodiment one, two, three, four, or the like foam nozzles dispense the expanding foam insulation 54 onto on the one or more substrates 24, 26, such as the first substrate 24. As the first substrate 24 and the second substrate 26 move down the line toward the laminator 160, the insulation material begins to expand between the first substrate 24 and the second substrate 26. As further illustrated in FIGS. 7A through 7C, the sloped liner entry 150 directs the second substrate 26 towards the laminator 160 to be laminated with the expanding insulation material 50 and the first substrate 24.

The laminator 160, as illustrated in FIGS. 7A through 7C, uses heat and/or pressure to laminate the first substrate 24, the expanding insulation material 50, and the second substrate 26 into the PCM panel 22. Moreover, the laminator 160 has molds at the edges of the first substrate 24 and the second substrate 26 that aid in forming the edges 34, 36 of the PCM panel 22 (e.g., the projections 40 and the cavities 42 formed by the projections 40) and/or restricting the expanding insulation material from foaming outside of the envelope of the insulated panel 22 onto unintended locations of the laminator 160.

After the PCM panel 22 is formed, the panel separator 170 (e.g., saw, cutter, blade, knife, laser, plasma, liquid, or the like) is used to separate the PCM panel 22 exiting the laminator 160 into the desired lengths, and thus forming the ends 30, 32 of the individual panels 22. After separating, the accelerator table 180 may be used to speed up the movement of the separated PCM panels 22 towards the next station, such as the panel flipper 190, cooling rack 200, and/or other station, where the PCM panels 22 are allowed to fully cure. After the PCM panels 22 have fully cured and cooled, the panel flipper 190 and/or panel conveyor 210 may move the PCM panels 22 toward a bundle wrapper 220 for packaging the PCM panels 22 before they are shipped to the customer.

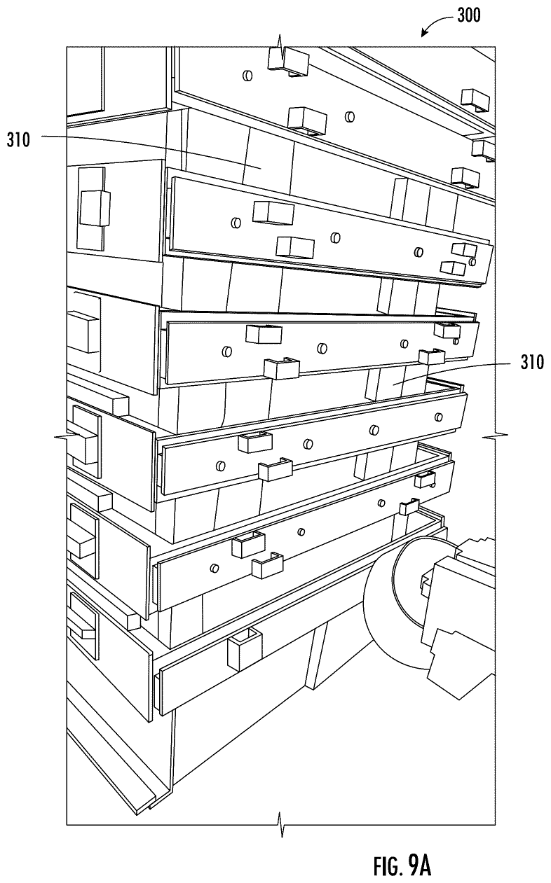

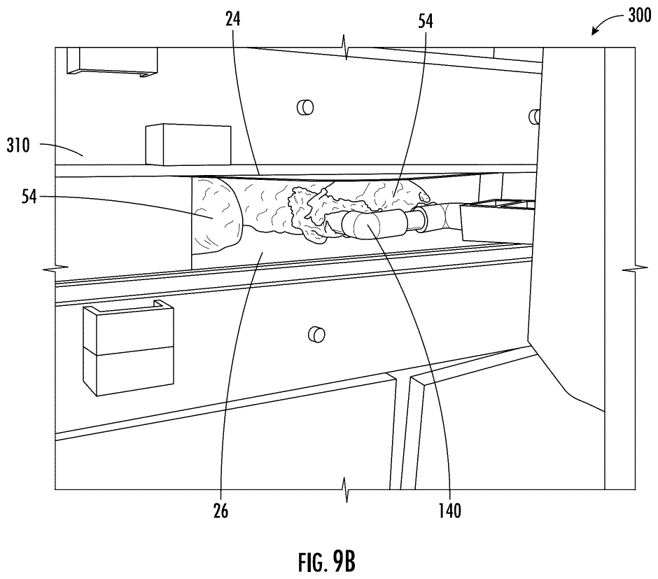

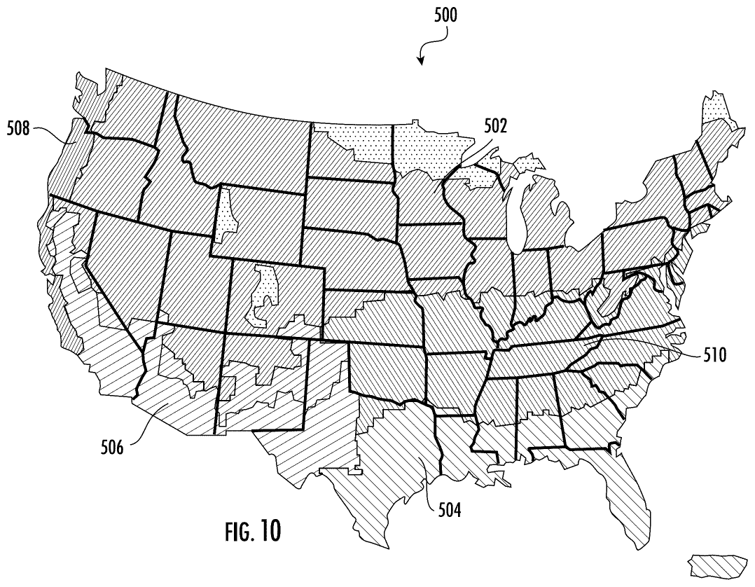

In alternate embodiments of the invention, as illustrated in FIGS. 9A and 9B, the equipment may be discontinuous panel manufacturing equipment 300. As such, in some embodiments, the uncoiliers, rollformers, and/or substrate separators may be used to form the first substrate 24 and/or second substrate 26 with the edges 34, 36. The first substrates 24 and/or second substrates 26 may be inserted into one or more molds 310 that set the length, width, and height of the PCM panels 22. One or more moveable applicators 140 (e.g., at the same time or in succession) may extend into an aperture in the mold(s) between the first substate 24 and the second substrate 26 and deposit (e.g., spay, distribute, or the like) the unexpanded material 52 into the one or more molds as the one or more moveable applicators 140 are withdrawn from the one or more molds (or the molds are moved with respect to the one or more applicators 140, or combinations thereof). The apertures in the molds may be covered, and the expanding insulation material 52 continues to expand within the molds. The molds are allowed sit until the insulation material 50 fully expands and cures.

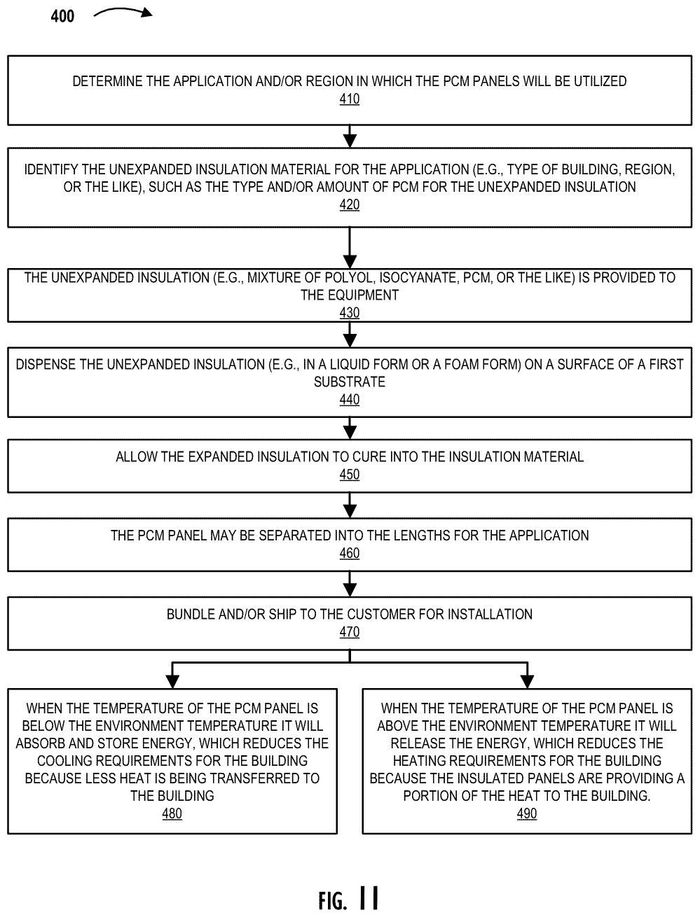

Regardless of how the PCM panels 22 are manufactured, Tables 1 and 2 below, as well as FIGS. 10 and 11, will be described with respect to the process of determining what PCM insulated panel 22 to form, the method of forming the PCM panel 22, the operation of the PCM panels 22 within the PCM insulation system 20 after installation, and the benefits of the foregoing. It should be understood that the PCM insulated panels 22 may be designed for different applications (e.g., regions that have different climates, types of buildings, or the like), as will be described herein. In particular, the PCM panels 22 may be designed for a target temperatures within a particular region and/or for a particular type of building. As illustrated in Table 1 below, the PCM insulated panels 22 may have preferred target ranges at which the solid-to-solid phase change may take place. That is, depending on the amount, type, and approach of forming the PCM material 60 included in the unexpanded insulation material 52, and/or the distribution of such PCM material 60 within the insulation material 50 after expanding and curing, the temperature at which PCM panel 22 may switch from storing thermal energy to releasing thermal energy, and vice versa, may be controlled.

TABLE 1
PCM Insulated Panel Temperature Ranges

| | Preferred PCM Inside | PCM Target | Alternate PCM Target |
|---|---|---|---|
| Application | Target Temp. Range | Temp. Range | Temp. Range |
| General Building | 71.6 to 73.4 degrees F. | 68 to 77 degrees F. | 64.4 to 80.6 degrees F. |
| | (22 to 23 degrees C.) | (20 to 25 degrees F.) | (18 to 27 degrees C.) |
| Cold Storage | 39.2 to 41 degrees F. | 37.4 to 42.8 degrees F. | 33.8 to 46.4 degrees F. |
| | (4 to 5 degrees C.) | (3 to 6 degrees C.) | (1 to 8 degrees C.) |
| Freezer | −4 to 0 degrees F. | −7.6 to 3.2 degrees F. | −11.2 to 6.8 degrees F. |
| | (−20 to −18 degrees C.) | (−22 to −16 degrees C.) | (−24 to −14 degrees C.) |
| Blast Freezer | −41.8 to −38.2 F. | −45.4 to −32.8 F. | −49 to −29.2 F. |
| | (−41 to −39 degrees C.) | (−43 to −36 degrees C.) | (−45 to −34 degrees C.) |

As illustrated in Table 1, the PCM panel 22 may be designed for general building applications, cold storage building applications, freezer building applications, and/or blast freezer building applications as outlined in Table 1. However, it should be understood that the PCM panel 22 may be designed for other applications not specifically discussed herein, and/or as specified by the customer for a particular customized application. Moreover, it should be further understood that the ranges under which the PCM panel 22 may operate, regardless of the particular type of building, may fall between, overlap, and/or fall outside of the values illustrated in Table 1. As such, the target phase-change temperature, and/or range thereof, for the PCM panels 22 described herein may vary by plus or minus 1, 2, 3, 4, 5, 10, 15, 20, 25, 30, 40, 50, 60, 70, 75, 80, 90, or the like percentage.

In order to achieve the target temperature (or range thereof) for the phase-change of the PCM panel 22, the insulation material may comprise approximately 5, 6, 7, 8, 9, 10, 11, 12, 13, 14, 15, 16, 17, 18, 19, 20, 25, 30, 35, 40, 45, 50, or the like percent of phase-change material (or otherwise range between, overlap, or fall outside of any of these values). The amount of phase-change material used within the insulation material may be altered depending on the proposed end-use of the PCM panel, the type of climate in which the PCM panel may be used, the thickness of PCM panel, and/or other like conditions in order to obtain different thermal protection and/or improved efficiency of the structure.

As illustrated in FIG. 10 and Table 2 below, the PCM panels 22 may be designed and/or tested for use in particular regions and/or climates, such as the climates illustrated in FIG. 10 for the estimated yearly temperature ranges (illustrated in degrees Celsius). That is, the PCM insulated panels 22 may operate in different environments 500, which may have temperatures over a twelve-month period that generally fall within the ranges illustrated in Table 2. For example, the PCM panels 22 may be configured for use in cold/very cold climates 502, hot/humid climates 504, hot-dry/mixed-dry climates 506, marine climates 508, mixed humid climates 510, combinations thereof, further split into other climates (e.g., separate cold and very cold climates, separate hot-dry and mixed-dry climates, or the like), or in other climates not specifically recited herein.

TABLE 2
Temperature Ranges at Which the PCM Insulated Panels may Operate.

| Regions | deg C. | January | February | March | April | May | June | July | August | September | October | November | December |
|---|---|---|---|---|---|---|---|---|---|---|---|---|---|
| Cold/Very Cold | High | −5 | 0 | 5 | 15 | 20 | 25 | 30 | 25 | 20 | 15 | 5 | 0 |
| | Low | −15 | −10 | −5 | 5 | 10 | 15 | 20 | 15 | 10 | 5 | −5 | −10 |
| Hot Humid | High | 15 | 15 | 20 | 25 | 30 | 35 | 40 | 40 | 35 | 30 | 20 | 20 |
| | Low | 10 | 10 | 15 | 15 | 20 | 25 | 25 | 25 | 20 | 20 | 15 | 10 |
| Hot-Dry/Mixed-Dry | High | 20 | 20 | 25 | 30 | 35 | 40 | 45 | 45 | 40 | 35 | 25 | 20 |
| | Low | 5 | 5 | 15 | 20 | 20 | 25 | 30 | 30 | 25 | 20 | 10 | 5 |
| Marine | High | 10 | 10 | 15 | 15 | 20 | 20 | 25 | 25 | 20 | 15 | 10 | 10 |
| | Low | 5 | 5 | 5 | 5 | 10 | 10 | 15 | 15 | 19 | 5 | 5 | 5 |
| Mixed Humid | High | 10 | 10 | 15 | 20 | 25 | 25 | 30 | 30 | 25 | 20 | 15 | 10 |
| | Low | 0 | 0 | 5 | 10 | 15 | 15 | 20 | 20 | 15 | 10 | 5 | 0 |

As tested and/or modeled (e.g., through computer aided modeling, or the like), the energy savings for each of these climates were calculated based on the estimated operation of the phase change for each of the months. It should be understood that depending on the time of year and the location at which the phase changed occurred the energy savings for using the PCM insulated panels 22 may be improved by 1, 5, 10, 15, 20, 25, 30, 35, 45, 50, 60, 70, 80, 90, 100, 125, 150, 175, 200, 300, 400, 500 percent, or the like, or range between, fall outside of, or overlap any of these percentages.

As described herein, it should be understood that the phase-change material of the present disclosure may provide improved thermal performance over traditional insulation that does not utilize the phase-change material. In particular, the PCM panels 22 may provide improved thermal performance when compared to traditional panels, or otherwise allow the PCM panels 22 to have smaller thicknesses compared to traditional panels that have the same thermal performance. For example, the thermal performance of the insulated panels may be measured by an R-value. Depending on the application for the insulated panels, the R-value may be 2, 4, 5, 6, 7, 8, 9, 10, 11, 12, 13, 14, 15, 16, 17, 18, 19, 20, 22, 24, 26, 28, 30, 35, 40, 45, 50, 55, 60, 65, 70, or the like (or otherwise range between, overlap, or fall outside of any of these R-values). The PCM panels 22 may provide a 2, 4, 6, 8, 10, 12, 14, 15, 16, 18, 20, 22, 24, 25, 26, 28, 30, 32, 34, 36, 38, 40, 45, 50, 55, 60, 65, 70, 75 or the like percentage increase in the R-values over the R-values of traditional insulated panels having the same thicknesses (or range between, overlap, or fall outside of any of these percentage values). Additionally, or alternatively, the PCM panels 22 may have thicknesses that are reduced by 2, 4, 5, 6, 8, 10, 15, 20, 25, 30, 35, 40, 45, 50, 55, 60, 65, 70, 75, or the like percentage with respect to traditional insulated panels that have the same R-value.

In addition to providing the phase-change benefits discussed herein, the PCM panels 22, like traditional panels, still meet the specifications that traditional panel meet, such as but not limited to water absorption of less than or equal to 30% (under ASTM C272/AC04); density of greater than or equal to 2.0 lb/ft³ (under ASTM D1622); mass loss of less than or equal to 20% (under ASTM C421); core compression (x) that is greater than or equal to 20 lb/in², core compression (y) that is approximately equal to the core compression (x), and/or core compression (z) that is less than or equal to twice the core compression (x) (under ASTM D1621); tensile adhesion (face) and tensile adhesion (foam) that is greater than or equal to 20 lb/in², and tensile adhesion (liner) that is greater than or equal to 16 lb/in² (under ASTM D1623); thermal conductivity at 75 degrees F. that is less than or equal to 0.140 BTU*in/hr*ft2* degree|R of 7.1 per inch, and thermal conductivity at 35 degrees F. that is less than or equal to 0.112 BTU*in/hr*ft2*degree|R of 7.1 per inch (under ASTM C518); and/or other specification not specifically outlined herein at the time of filing this application or as updated from time to time.

Turning to FIG. 11, as illustrated in block 410, a determination is made regarding the application for the PCM insulated panel system 20, such as the type of building (e.g., general building, cold storage, freezer, blast freezer, or the like), the region (e.g., based on average temperature, or the like throughout the year in the location), customized application, or the like.

Block 420 of FIG. 11 illustrates that the unexpanded insulation material for the application is determined. That is, the unexpanded insultation (e.g., with the amount, type, or the like of PCM) that provides the desired phase change temperature for the PCM panels 22 is determined. For example, the type of PCM material 60 (e.g., components, approach for forming, the PCM, or the like) and/or the combination with the other components of the unexpanded insulation 52 is determined for the application determined from block 410.

FIG. 11 further illustrates in block 430 that the unexpanded insulation for the particular application is supplied to the equipment that is being used to create the PCM panels 22. As previously described herein, the PCM material 60 is included in the unexpanded insulation and distributed as evenly as possible within the unexpanded insulation. As such, in some embodiments the PCM material 60 is microencapsulated within the poly blend and/or the isocyanate before being deposited onto the substrate and/or within a mold.

Block 440 of FIG. 11 illustrates during operation the equipment, the unexpanded insulation is deposited onto a surface of at least a first substrate 24 (e.g., in a liquid form, in a foam form, or the like). As previously discussed herein, the first substrate 24, the insulation material 50, and/or the second substrate 26 may be laminated together in a laminator as the unexpanded insulation is allowed to expand. Alternatively, the unexpanded insulation may be deposited into a mold, in which the first substrate 24 and the second substrate 26 are located and allowed to expand within the mold.

FIG. 11 further illustrates in block 450 that the expanded insulation material between the substrates is allowed to cure to form the PCM panel 22.

Block 460 of FIG. 11 further illustrates that in some embodiments, the PCM panel 22 may be separated into the lengths required for the application in which the PCM panel 22 will be installed.

FIG. 11 of block 470 illustrates that multiple PCM panels 22 may be bundled and shipped to the customer for installation the PCM panel system 20 onto the building.

Block 480 of FIG. 11 illustrates that during operation, when the temperature of the PCM panel 22 is below the environment temperature it will absorb and store energy, which reduces the cooling requirements for the building because less heat is being transferred to the building. Alternatively, as illustrated in block 490 of FIG. 11, when the temperature of the PCM panel 22 is above the environment temperature it will release the energy, which reduces the heating requirements for the building because the insulated panels are providing a portion of the heat to the building.

The present invention provides improvements over traditional insulated panels because the PCM panels 22 saves the amount of energy required for heating and/or cooling. Moreover, the present invention provides improvements because it utilizes solid-to-solid PCM material instead of solid-to-liquid PCM material, which may cause issues in supporting the PCM material within the insulated panels (e.g., during the liquid phase). Furthermore, by micro-incapsulating the PCM in the unexpanded insulation and allowing the PCM material 60 to be distributed as the unexpanded insulation material expands, traditional insulated panel equipment maybe utilized in order to form the PCM panels 22. As such, specialized equipment is not necessary in order to form the PCM panels 22 described herein.

While the present invention has been described with particular reference to the drawings, it should be understood that various modifications could be made without departing from the spirit and scope of the present invention. For instance, while the PCM panels 22 are shown and described as being connected to the support members 12 in a particular way, the panels may be rotated 180 degrees, such that the first edge 34 is the second edge 36 without departing from the spirit and scope of the present invention. Additionally, the entire system may be rotated 90 such that the edges 34, 36 are oriented vertically not horizontally.

It should be understood that “operatively coupled,” when used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together.

Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more.”

Certain terminology is used herein for convenience only and is not to be taken as a limiting, unless such terminology is specifically described herein for specific embodiments. For example, words such as “top”, “bottom”, “upper”, “lower”, or the like may merely describe the configurations shown in the figures and described herein for some embodiments of the invention. Indeed, the components may be oriented in any direction and the terminology, therefore, should be understood as encompassing such variations unless specified otherwise. The terminology includes the words specifically mentioned above, derivatives thereof and words of similar import.

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A phase-change insulated panel comprising:
a first substrate;
a second substrate;
an insulation material located between the first substrate and the second substrate, wherein the insulation material comprises a phase change material (PCM) microencapsulated within the insulation material, and wherein the PCM is a solid-to-solid PCM.

2. The phase-change insulated panel of claim 1, wherein the insulation material is formed from an unexpanded insulation material comprising:
a polyol;
an isocyanate; and
the PCM,
wherein the unexpanded insulation material is deposited between the first substrate and the second substrate in a liquid form or a foam form and allowed to expand into the insulation material.

3. The phase-change insulated panel of claim 2, wherein the unexpanded insulation material further comprises:
a catalyst;
a fire retardant;
a surfactant;
processing additives; and
water.

4. The phase-change insulated panel of claim 1, wherein the insulation material is a polyurethane foam with the microencapsulated PCM.

5. The phase-change insulated panel of claim 1, wherein the insulation material is a polyisocyanurate foam with the microencapsulated PCM.

6. The phase-change insulated panel of claim 1, wherein the insulation material is applied as liquid PCM material with the microencapsulated PCM within the liquid PCM and allowed to harden into the insulation material.

7. The phase-change insulated panel of claim 1, wherein a phase change of the PCM within the insulation material occurs at a temperature range from 64.4 to 80.6 degrees F.

8. The phase-change insulated panel of claim 1, wherein a phase change of the PCM within the insulation material occurs at a temperature range from 33.8 to 46.4 degrees F.

9. The phase-change insulated panel of claim 1, wherein a phase change of the PCM within the insulation material occurs at a temperature range from −11.2 to 6.8 degrees F.

10. The phase-change insulated panel of claim 1, wherein a phase change of the PCM within the insulation material occurs at a temperature range from −49 to −29.2 degrees F.

11. A method of forming a phase-change insulated panel, wherein the phase-change insulated panel comprises a first substrate, a second substrate, and an insulation material between the first substrate and the second substrate, wherein the insulation material comprises a phase change material (PCM) microencapsulated within the insulation material, and wherein the PCM is a solid-to-solid PCM, the method comprising:
dispensing an unexpanded insulation material onto at least a first substrate through an applicator in a liquid form or a foam form; and
allowing the unexpanded insulation material to expand into the insulation material between the first substrate and a second substrate.

12. The method of claim 11, wherein the applicator comprises one or more stationary nozzles.

13. The method of claim 11, further comprising:
applying the second substrate to the insulation material; and
laminating the first substrate, the insulation material, and the second substrate together as the unexpanded insulation material is expanding into the insulation material.

14. The method of claim 11, wherein the applicator comprises one or more moveable nozzles.

15. The method of claim 14, further comprising;
inserting the applicator into a first mold between the first substrate and the second substrate;
wherein the dispensing occurs as the applicator is withdrawn from the mold.

16. The method of claim 11, wherein the unexpanded insulation material comprises:
a polyol;
an isocyanate; and
the PCM.

17. The method of claim 11, wherein the unexpanded insulation material further comprises:
a catalyst;
a fire retardant;
a surfactant;
processing additives; and
water.

18. The phase-change insulated panel of claim 1, wherein the insulation material is a polyurethane foam with the microencapsulated PCM or a polyisocyanurate foam with the microencapsulated PCM.

19. The phase-change insulated panel of claim 1, wherein a phase change of the PCM within the insulation material occurs at a temperature range from 64.4 to 80.6 degrees F. or at a temperature range from 33.8 to 46.4 degrees F.

20. The phase-change insulated panel of claim 1, wherein a phase change of the PCM within the insulation material occurs at a temperature range from −11.2 to 6.8 degrees F. or at a temperature range from −49 to −29.2 degrees F.
